(19) United States
(12) Patent Application Publication
(10) Pub. No.: US 2026/0140909 A1
(43) Pub. Date: May 21, 2026

(54) EXPANSION DEVICE HAVING HIGH-SPEED INTERFACE AND/OR A BASE DEVICE HAVING HIGH-SPEED INTERFACE

(71) Applicant: KLAS TECHNOLOGIES LIMITED, Dublin 8 (IE)

(72) Inventors: Ciaran LONG, Dublin 8 (IE); Eoin MOONEY, Dublin 8 (IE)

(21) Appl. No.: 18/955,507

(22) Filed: Nov. 21, 2024

(51) Int. Cl. G06F 13/40

(52) U.S. Cl. CPC G06F 13/409; G06F 2213/0026

(57) ABSTRACT

A device includes an expansion interface, a plurality of mechanical connectors, where the expansion interface of the expansion device is configured to electrically connect to a base device in order to exchange data and/or signals between the expansion device and the base device, where the plurality of mechanical connectors of the expansion device are configured to mechanically connect the expansion device to the base device in order to provide a combined configuration of the expansion device and the base device.

### FIELD OF THE DISCLOSURE

The disclosure relates to an expansion device having a high-speed interface. The disclosure also relates to a base device having a high-speed interface.

### BACKGROUND OF THE DISCLOSURE

Typical expansion devices that are implemented in separate housings from a base device are connected to the base device or primary device with one or more wired connections between a housing of the base device or primary device and the housing of the expansion device. These wired connections are less rugged and accordingly may be a possible source of failures in harsh environments. Additionally, these wired connections increase a length a signal must travel between the base device and the expansion device. This can impact signal performance, data transfer performance, and/or the like between the base device and the expansion device.

Accordingly, an improved connection between a base device and expansion device is needed.

### SUMMARY OF THE DISCLOSURE

The foregoing needs are met, to a great extent, by the disclosure, wherein in one aspect an expansion device having a high-speed interface is provided.

In one aspect, the expansion device includes an expansion interface. The expansion device in addition includes a plurality of mechanical connectors. The device moreover includes where the expansion interface of the expansion device is configured to electrically connect to a base device in order to exchange data and/or signals between the expansion device and the base device. The device also includes where the plurality of mechanical connectors of the expansion device are configured to mechanically connect the expansion device to the base device in order to provide a combined configuration of the expansion device and the base device.

In one aspect, the expansion device includes an expansion interface. The expansion device in addition includes a plurality of mechanical connectors. The device moreover includes where the expansion interface of the expansion device is configured to electrically connect to a base device in order to exchange data and/or signals between the expansion device and the base device. The device also includes where the plurality of mechanical connectors of the expansion device are configured to mechanically connect the expansion device to the base device in order to provide a combined configuration of the expansion device and the base device. The device further includes where the expansion interface is configured to move with respect to the expansion device in at least two directions.

In one aspect, a system includes a base device. The system also includes an expansion device having an expansion interface and a plurality of mechanical connectors. The system furthermore includes where the expansion interface of the expansion device is configured to electrically connect to the base device in order to exchange data and/or signals between the expansion device and the base device. The system in addition includes where the plurality of mechanical connectors of the expansion device are configured to mechanically connect the expansion device to the base device in order to provide a combined configuration of the expansion device and the base device.

In one aspect, a system includes a base device. The system also includes an expansion device having an expansion interface and a plurality of mechanical connectors. The system furthermore includes where the expansion interface of the expansion device is configured to electrically connect to the base device in order to exchange data and/or signals between the expansion device and the base device. The system in addition includes where the plurality of mechanical connectors of the expansion device are configured to mechanically connect the expansion device to the base device in order to provide a combined configuration of the expansion device and the base device. The system moreover includes where the expansion interface is configured to move with respect to the expansion device in at least two directions.

There has thus been outlined, rather broadly, certain aspects of the disclosure in order that the detailed description thereof herein may be better understood, and in order that the present contribution to the art may be better appreciated. There are, of course, additional aspects of the disclosure that will be described below and which will form the subject matter of the claims appended hereto.

In this respect, before explaining at least one aspect of the disclosure in detail, it is to be understood that the disclosure is not limited in its application to the details of construction and to the arrangements of the components set forth in the following description or illustrated in the drawings. The disclosure is capable of aspects in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the disclosure. It is important, therefore, that the claims be regarded as including such equivalent constructions insofar as they do not depart from the spirit and scope of the disclosure.

### BRIEF DESCRIPTION OF THE DRAWINGS

FIG. 1A that illustrates a perspective view of an expansion device according to aspects of the disclosure.

FIG. 1B that illustrates a bottom view of the expansion device of FIG. 1A.

FIG. 1C that illustrates a front view of the expansion device of FIG. 1A.

FIG. 2A that illustrates a perspective view of an another expansion device according to aspects of the disclosure.

FIG. 2B that illustrates a bottom view of the another expansion device of FIG. 2A.

FIG. 2C that illustrates a front view of the another expansion device of FIG. 2A.

FIG. 3A that illustrates a perspective view of an expansion device according to FIG. 1 with a seal configuration.

FIG. 3B that illustrates a bottom view of the expansion device of FIG. 3A.

FIG. 3C that illustrates a front view of the expansion device of FIG. 3A.

FIG. 4A that illustrates a perspective view of a base device according to aspects of the disclosure.

FIG. 4B that illustrates a bottom view of the base device of FIG. 4A.

FIG. 4C that illustrates a front view of the base device of FIG. 4A.

FIG. 5 illustrates a bottom view of the base device according to FIG. 4A that includes a cover.

FIG. 6 illustrates a partial bottom view of the base device according to FIG. 4A.

FIG. 7 illustrates a perspective view of the expansion device and the base device prior to connection according to aspects of the disclosure.

FIG. 8 illustrates a perspective view of the plurality of mechanical connectors according to aspects of the disclosure.

FIG. 9 illustrates a cross-sectional view of the plurality of mechanical connectors of FIG. 8.

FIG. 10 illustrates a cross-sectional view of the base device with the plurality of mechanical connectors in a locked configuration according to aspects of the disclosure.

FIG. 11 illustrates a cross-sectional view of the base device with the plurality of mechanical connectors in an unlocked configuration according to aspects of the disclosure.

FIG. 12 illustrates a cross-sectional view of the expansion device and the base device with the plurality of mechanical connectors in a locked configuration according to aspects of the disclosure.

FIG. 13 illustrates a cross-sectional view of the expansion device and the base device with the plurality of mechanical connectors in an unlocked configuration according to aspects of the disclosure.

FIG. 14 illustrates a cross-sectional view of the expansion device and the expansion interface according to aspects of the disclosure.

FIG. 15 illustrates another cross-sectional view of the expansion device and the expansion interface according to aspects of the disclosure.

FIG. 16 illustrates a cross-sectional view of a particular implementation of the expansion device and the expansion interface according to aspects of the disclosure.

FIG. 17 illustrates a cross-sectional view of a particular implementation of the expansion device and the expansion interface according to aspects of the disclosure.

### DETAILED DESCRIPTION

The disclosure will now be described with reference to the drawing figures, in which like reference numerals refer to like parts throughout. Aspects of the disclosure advantageously provide an expansion device having a high-speed interface.

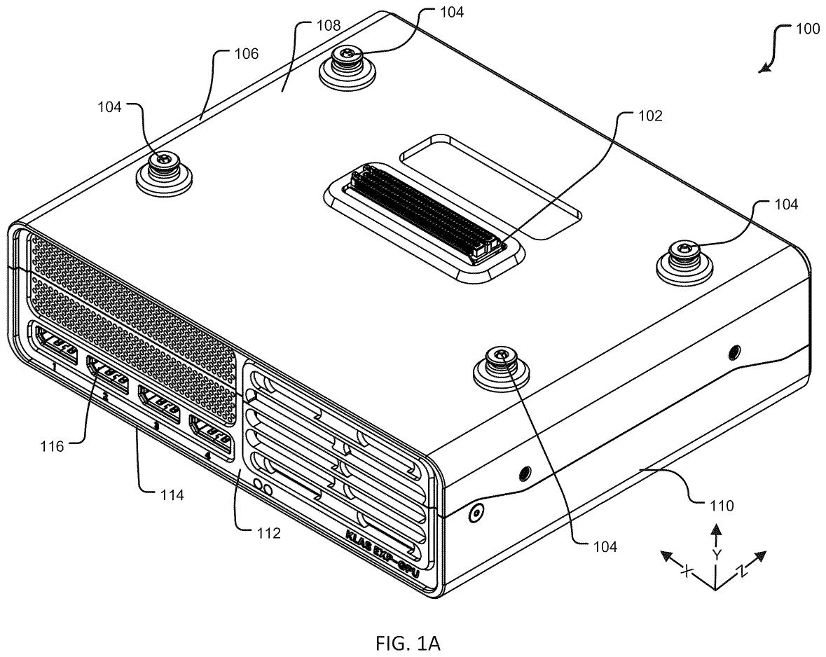

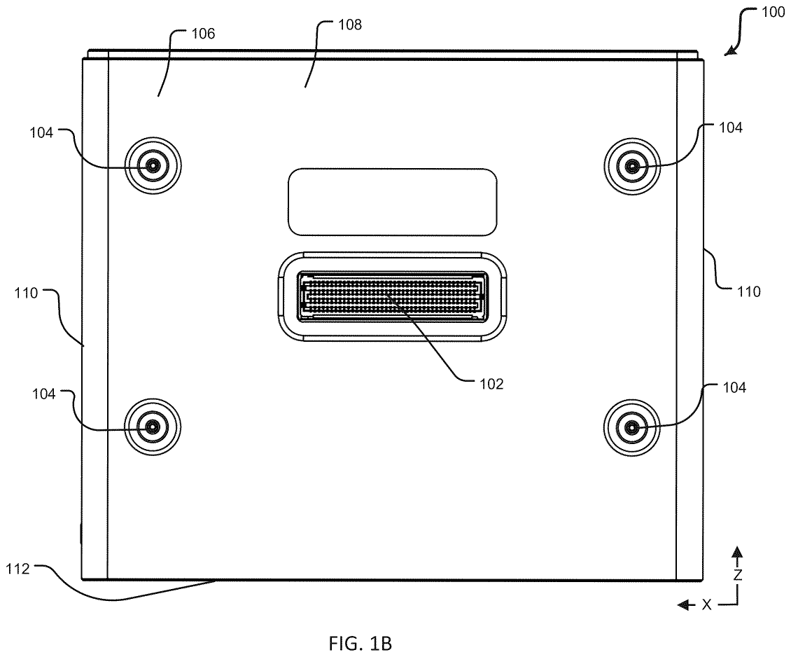

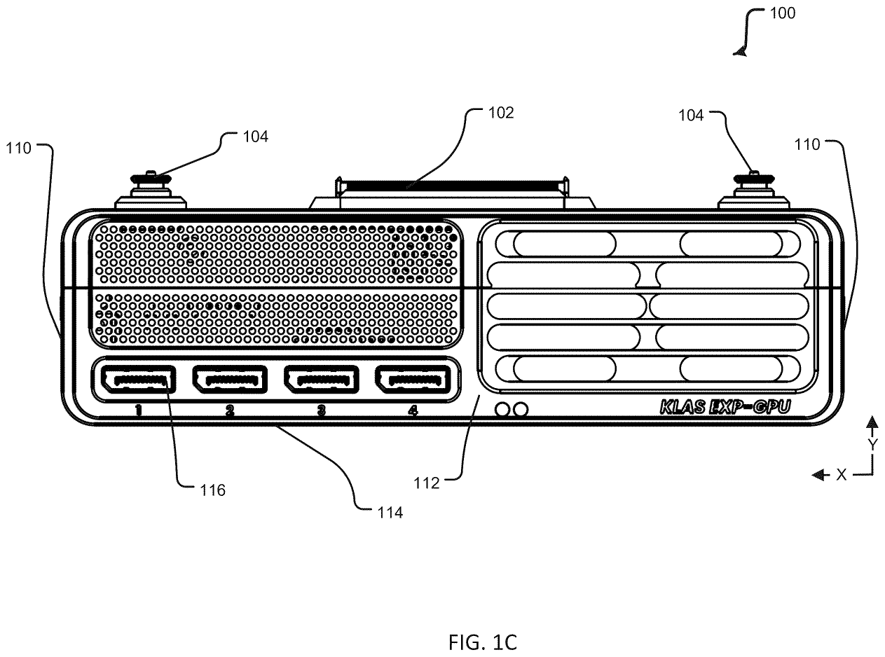

FIG. 1 includes: FIG. 1A that illustrates a perspective view of an expansion device according to aspects of the disclosure; FIG. 1B that illustrates a bottom view of the expansion device; and FIG. 1C that illustrates a front view of the expansion device.

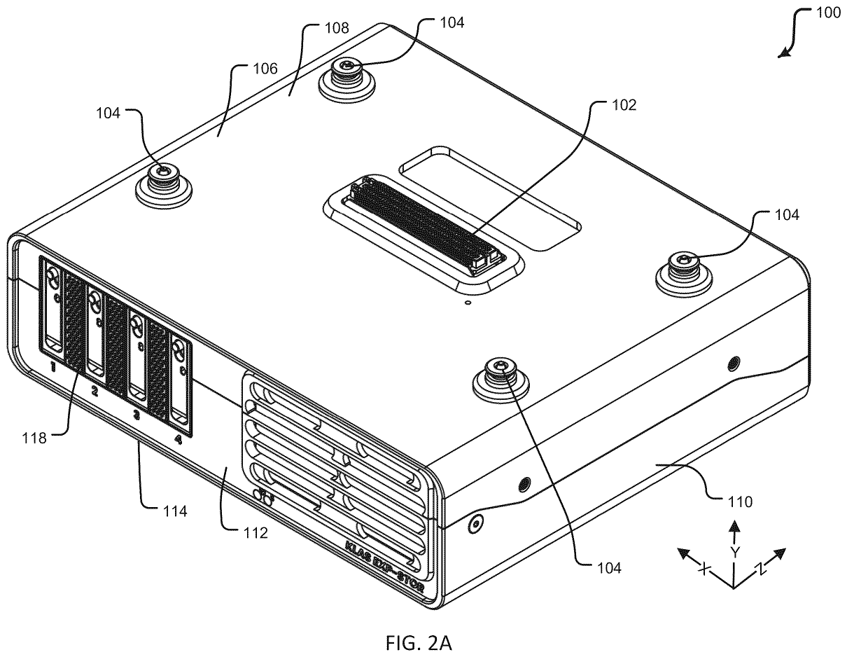

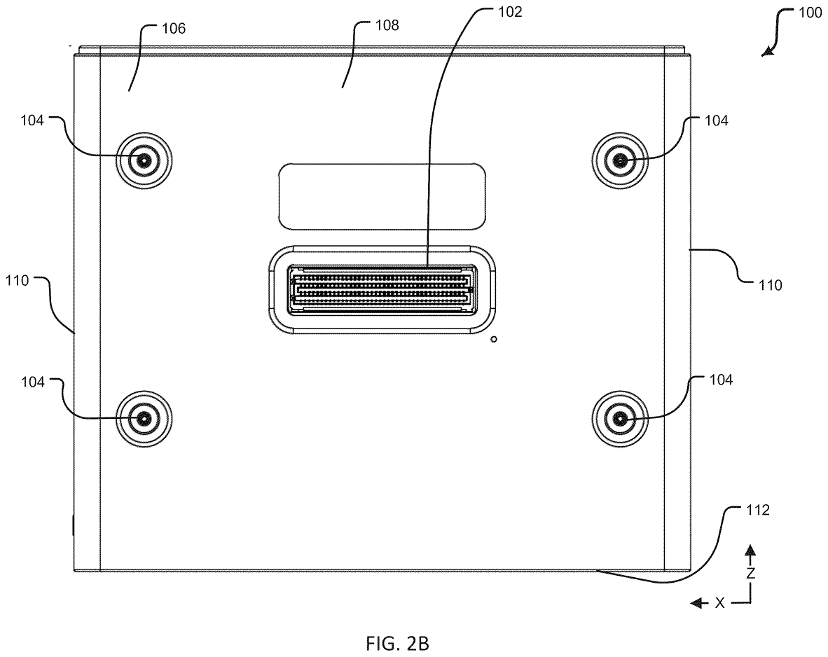

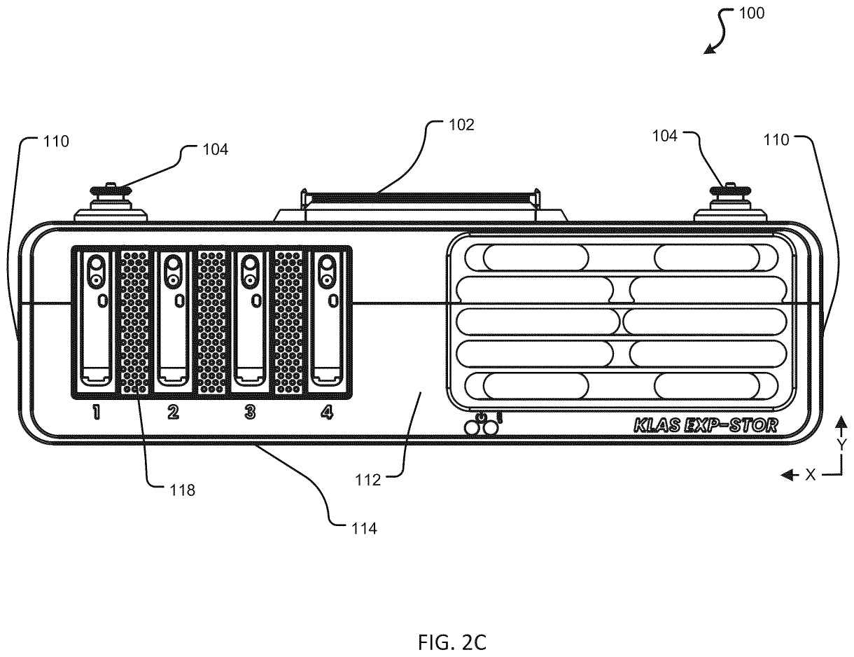

FIG. 2 includes: FIG. 2A that illustrates a perspective view of an another expansion device according to aspects of the disclosure; FIG. 2B that illustrates a bottom view of the another expansion device; and FIG. 2C that illustrates a front view of the another expansion device.

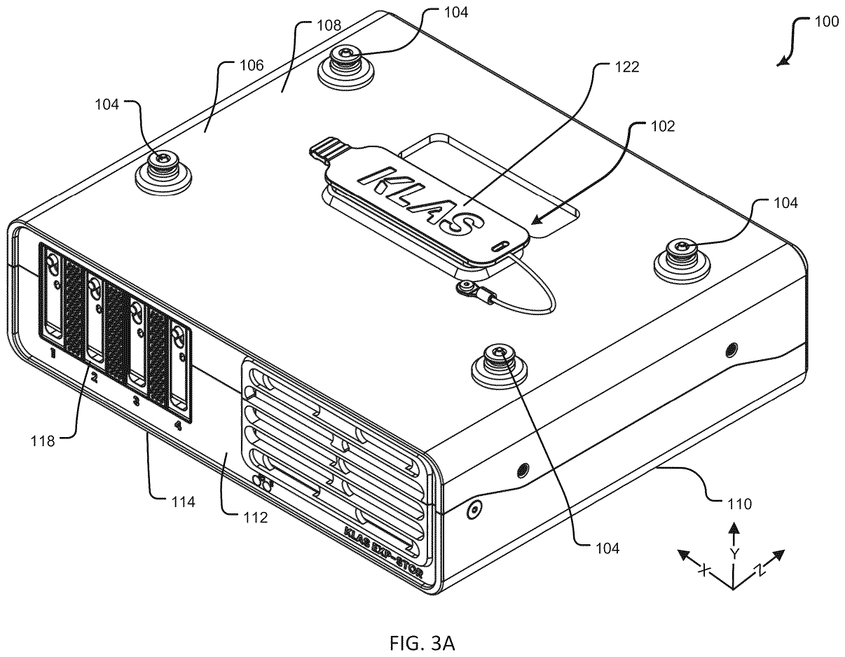

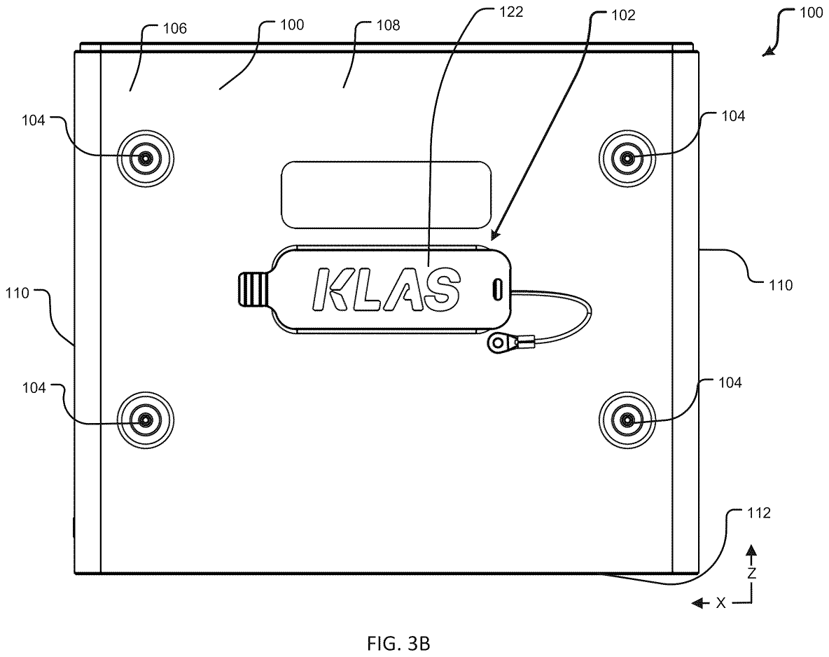

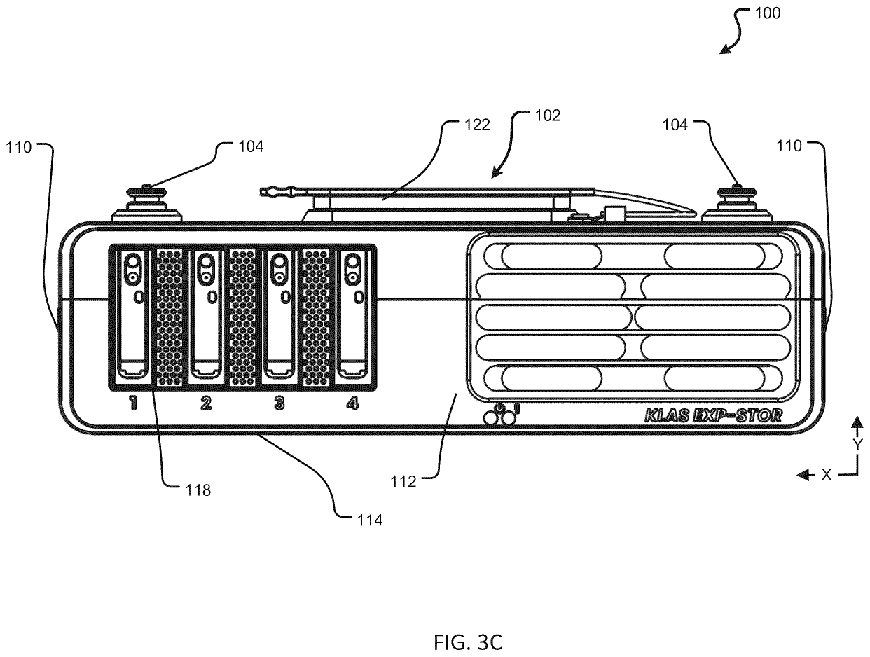

FIG. 3 includes: FIG. 3A that illustrates a perspective view of an expansion device according to FIG. 1 with a seal configuration; FIG. 3B that illustrates a bottom view of the expansion device; and FIG. 3C that illustrates a front view of the expansion device.

In particular, FIG. 1 illustrates an expansion device 100 according to aspects of the disclosure. The expansion device 100 may include an expansion interface 102 and a plurality of mechanical connectors 104. In aspects, the expansion device 100 may have two implementations of the plurality of mechanical connectors 104, three implementations of the plurality of mechanical connectors 104, four implementations of the plurality of mechanical connectors 104, five implementations of the plurality of mechanical connectors 104, six implementations of the plurality of mechanical connectors 104, or more than six implementations of the plurality of mechanical connectors 104.

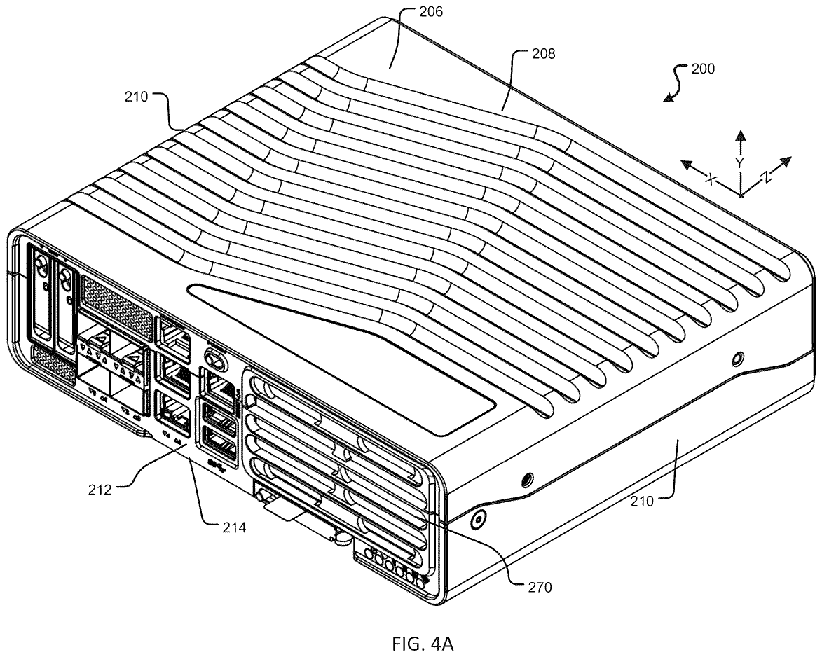

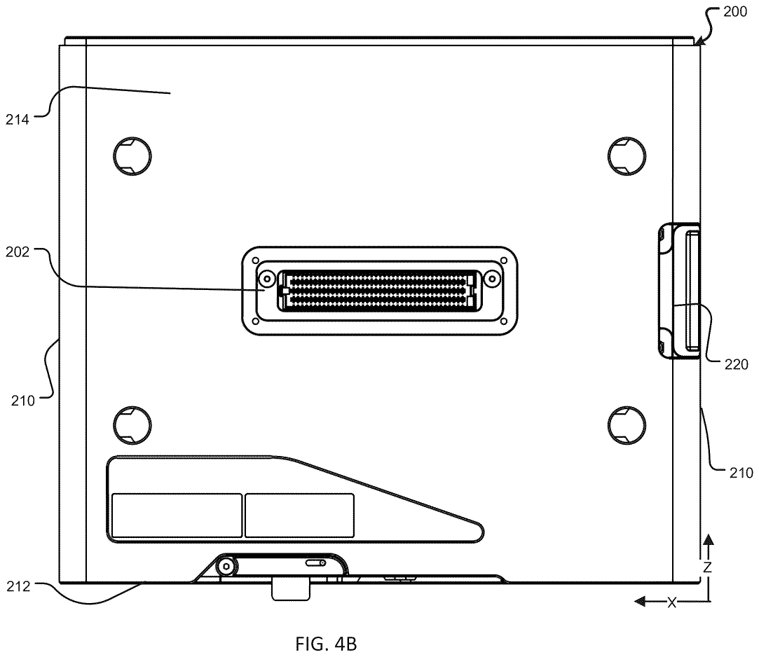

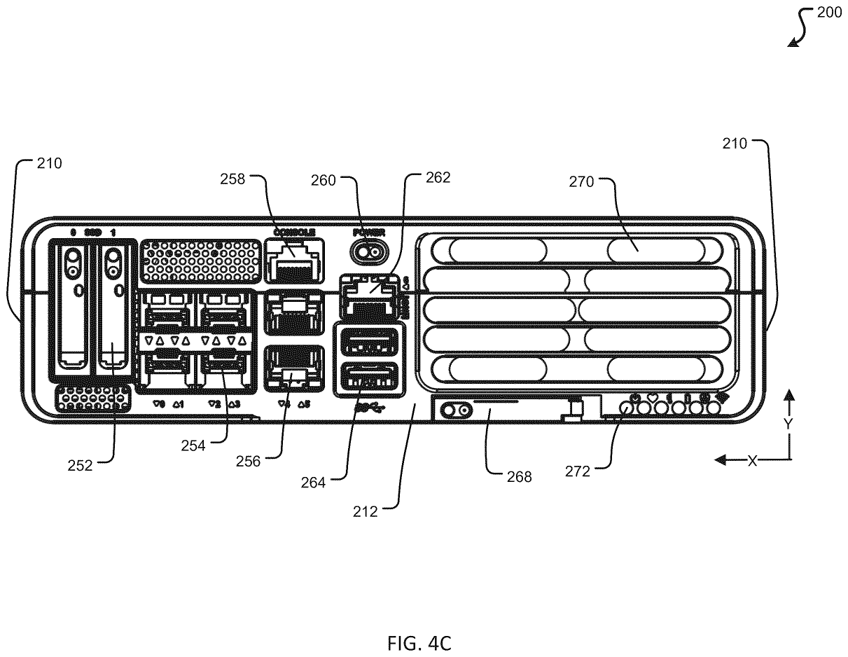

The expansion device 100 may be configured to connect to a base device 200, illustrated in FIG. 4. Further, the expansion interface 102 of the expansion device 100 may be configured to electrically connect to the base device 200 in order to exchange data and/or signals between the expansion device 100 and the base device 200.

Additionally, the plurality of mechanical connectors 104 of the expansion device 100 may be configured to mechanically connect the expansion device 100 to the base device 200 in order to provide a combined configuration of the expansion device 100 and the base device 200. Additionally, the plurality of mechanical connectors 104 may be configured to ensure alignment of the expansion interface 102 with a corresponding interface on the base device 200.

FIG. 4 includes: FIG. 4A that illustrates a perspective view of a base device according to aspects of the disclosure; FIG. 4B that illustrates a bottom view of the base device; and FIG. 4C that illustrates a front view of the base device.

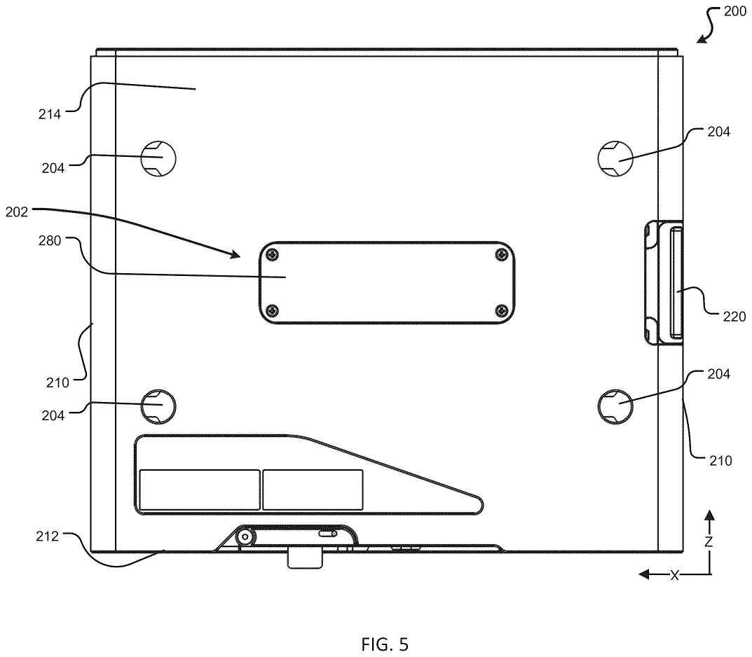

FIG. 5 illustrates a bottom view of the base device according to FIG. 4A that includes a cover.

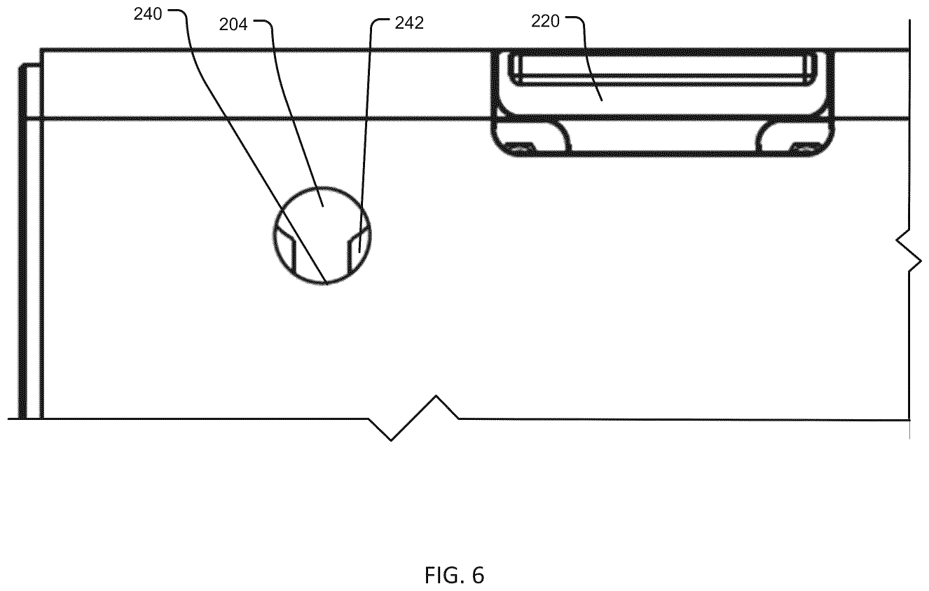

FIG. 6 illustrates a partial bottom view of the base device according to FIG. 4A.

In particular, FIG. 4 illustrates a base device 200 according to aspects of the disclosure. In aspects, the base device 200 may be a virtual machine, a server, and/or the like.

As illustrated in FIG. 4, the base device 200 may include an expansion interface 202 and a plurality of mechanical connectors 204. In aspects, the base device 200 may have two implementations of the plurality of mechanical connectors 204, three implementations of the plurality of mechanical connectors 204, four implementations of the plurality of mechanical connectors 204, five implementations of the plurality of mechanical connectors 204, six implementations of the plurality of mechanical connectors 204, or more than six implementations of the plurality of mechanical connectors 204.

Further, implementation of the expansion device 100 and/or the base device 200 as separate components allows for one to be replaced for upgrade, maintenance, repair, failure, alternative features, and/or the like. More specifically, implementation of the plurality of mechanical connectors 104 and the expansion interface 102 by the expansion device 100 and implementation of the expansion interface 202 and the plurality of mechanical connectors 204 by the base device 200 provides the ability for the expansion device 100 and/or the base device 200 to be easily and quickly replaced for upgrade, maintenance, repair, failure, alternative features, and/or the like.

The expansion device 100 and/or the base device 200 may be configured to have a small form factor, a light weight, and also further configured to be rugged and/or ruggedized as defined herein for implementation in harsh environments. More specifically, the expansion device 100 and/or the base device 200 may be configured to have a small form factor and a light weight relative to the types of implementations of the expansion device 100 and/or the base device 200 as described herein.

In some aspects, the expansion device 100 and/or the base device 200 may be configured for implementation in a 19 inch rack. Consequently, implementation of a size of the base device 200 may be limited due to the requirements that the base device 200 be implemented in such a rack. In this regard, due to size limitations, additional components cannot be implemented in the base device 200. Accordingly, additional components and/or functionality that is desired to be implemented and cannot be implemented in the base device 200 may be implemented in the expansion device 100. However, the expansion device 100 and/or the base device 200 may be configured for standalone implementations, implementations in other types of racks, other types of implementations, and/or the like.

In aspects, the expansion device 100 may be configured with additional computer functionality, computer components, graphics components, processing devices, storage, switch devices, networking devices, routing devices, and/or the like. Further, the expansion device 100 may be directly attached to the base device 200 to implement such features for the base device 200. In order to provide the base device 200 with high-speed access to the expansion device 100, the expansion device 100 and the base device 200 may be implemented with a high speed interface and/or high-speed interconnect. In particular, the expansion device 100 may be implemented with the expansion interface 102 configured as a high speed interface and/or high-speed interconnect; and the base device 200 may be implemented with the expansion interface 202 configured as a high speed interface and/or high-speed interconnect.

As further described herein, the expansion interface 102 of the expansion device 100 and the expansion interface 202 of the base device 200 may be implemented without wires. In aspects, the expansion interface 102 of the expansion device 100 and the expansion interface 202 of the base device 200 may be implemented with a plurality of lanes. In aspects, there may be two lanes, four lanes, eight lanes, sixteen lanes, thirty two lanes, or more. In aspects, each lane may implement one giga transfer per second (GT/s), two giga transfers per second (GT/s), four giga transfers per second (GT/s), or more.

In aspects, the expansion interface 102 of the expansion device 100 and the expansion interface 202 of the base device 200 may be implemented with a plurality of peripheral Component Interconnect Express (PCIe) interface lanes. In aspects, there may be two PCIe lanes, four PCIe lanes, eight PCIe lanes, sixteen PCIe lanes, thirty two PCIe lanes, or more. In aspects, each PCIe lane may implement one giga transfer per second (GT/s), two giga transfers per second (GT/s), four giga transfers per second (GT/s), or more.

In particular aspects, the expansion interface 102 of the expansion device 100 and the expansion interface 202 of the base device 200 may be implemented with a plurality of peripheral Component Interconnect Express (PCIe) Gen 4 interface lanes. In aspects, there may be two PCIe lanes, four PCIe lanes, eight PCIe Gen 4 lanes, sixteen PCIe Gen 4 lanes, thirty two PCIe Gen 4 lanes, or more. In aspects, each PCIe Gen 4 lane may implement one giga transfer per second (GT/s), two giga transfers per second (GT/s), four giga transfers per second (GT/s), or more. However, the features described herein may be implemented in future generations of PCIe.

Moreover, high-speed as defined herein may be 8 giga transfers per second (GT/s), 16 giga transfers per second (GT/s), 32 giga transfers per second (GT/s), or more. Further, this may approximate 8 gigabits per second (Gb/s), 16 gigabits per second (Gb/s), 32 gigabits per second (Gb/s), or more respectively. This is in contrast to a USB device that may operate at most 5 Gb/s.

Components of the base device 200 may be implemented on a carrier that connects to the expansion interface 202 of the base device 200. The expansion interface 202 of the base device 200 connects to the expansion interface 102 of the expansion device 100. The expansion interface 102 of the expansion device 100 may be implemented as a floating connector and the expansion interface 102 may be connected to a carrier implementing components of the expansion device 100. In particular aspects, the expansion interface 102 of the expansion device 100 may be configured to float in a context of tolerance in the connectors. More specifically, the expansion interface 102 of the expansion device 100 may be configured to float to provide a tolerance for a connection between the expansion interface 102 and the expansion interface 202. The expansion interface 102 may be implemented as a floating connector providing tolerance in connecting to the expansion interface 202 of the base device 200.

Implementing the expansion interface 102 avoids the need to implement wired connections between a separately housed implementation of the expansion device 100 and a separately housed implementation of the base device 200 and associated signal loss of such wired connections. In particular, the physical lengths and distances between the expansion device 100 implementing the expansion interface 102 and the base device 200 implementing the expansion interface 202 are much less than an implementation that would include wired connections. It should be noted that this is distinguished from typical slotted connections of components within a single housing. Such slotted connections do not relate to separately housed implementations as disclosed. Moreover, such slotted connections do not relate to ruggedized implementations as described herein.

Further, implementation of the expansion interface 102 of the expansion device 100 may include low loss printed circuit board configurations to further limit and/or avoid signal loss; and implementation of the expansion interface 202 of the base device 200 includes low loss printed circuit board configurations to further limit and/or avoid signal loss. In other words, losses in the respective printed board configurations of the expansion device 100 and the base device 200 may be very small.

Additionally, implementation of the expansion interface 102 of the expansion device 100 may include driver configurations to amplify signals to further limit and/or avoid signal loss; and/or implementation of the expansion interface 202 of the base device 200 may include driver configurations to amplify signals to further limit and/or avoid signal loss. In particular aspects, the driver configurations may be implemented as a driver chip for each signal line, each lane, and/or the like.

In aspects, the expansion device 100 and/or the base device 200 may be configured to be ruggedized as defined herein, to allow for implementation in high vibration environments such as vehicles. In this regard, implementation of the expansion interface 102 of the expansion device 100 and/or the expansion interface 202 of the base device 200 may be configured to operate in high vibration environments without significant signal loss. More specifically, implementation of the expansion interface 102 of the expansion device 100 and/or the expansion interface 202 of the base device 200 may allow for movement to compensate for the high vibration environments. In aspects, the configuration of the expansion interface 102 of the expansion device 100 may be configured for self-aligning during attachment of the base device 200 to the expansion device 100.

In aspects, the expansion interface 102 of the expansion device 100 and the expansion interface 202 of the base device 200 may be configured as external high-speed interfaces. Typical external expansion interfaces on computers tend to be relatively low speed, for example serial interfaces, USB interfaces, firewire interfaces, and/or the like.

In aspects, the expansion interface 102 of the expansion device 100 and the expansion interface 202 of the base device 200 may be configured as a Peripheral Component Interconnect Express (PCIe) interface. In aspects, the expansion interface 102 of the expansion device 100 and the expansion interface 202 of the base device 200 may be configured as a PCIe interface implementing two PCIe lanes, four PCIe lanes, eight PCIe lanes, sixteen PCIe lanes, thirty two PCIe lanes, or more PCIe lanes. Further, each PCIe lane may implement one giga transfer per second (GT/s), two giga transfers per second (GT/s), four giga transfers per second (GT/s), eight giga transfers per second (GT/s), or more on each lane.

Implementation of the expansion interface 102 of the expansion device 100 and the expansion interface 202 of the base device 200 may be significant in that it includes the ability to separately upgrade the expansion device 100 and/or the base device 200. For example, replace the base device 200 that may be implemented with a newer CPU (host); and/or add-on capability of the expansion device 100 (client) over time.

In aspects, implementation of the expansion interface 102 of the expansion device 100 and the expansion interface 202 of the base device 200 as an external expansion interface in effect facilitates splitting what would normally be one device into two devices (host and client) linked by the external expansion interface 102.

In aspects, the base device 200 may implement a CPU or compute module and may be implemented as the host; and the expansion device 100 may be implemented as a client.

In aspects, implementation of the expansion interface 102 of the expansion device 100 and the expansion interface 202 of the base device 200 as an external expansion interface means that there is no cable required. In other words, the expansion interface 102 of the expansion device 100 and the expansion interface 202 of the base device 200 are configured as a connector to connector interface.

In aspects, implementation of the plurality of mechanical connectors 104 of the expansion device 100 and the plurality of mechanical connectors 204 of the base device 200 provide an implementation where there is no chassis required to hold the two modules together (the expansion device 100 and the base device 200), although the two modules may be inserted into a chassis once connected, including into a standard 19′ rack-mount chassis for convenience, for example as part of a larger system. In aspects, implementation of the plurality of mechanical connectors 104 of the expansion device 100 and the plurality of mechanical connectors 204 of the base device 200 provide a ruggedized, as defined herein, and combined configuration of the expansion device 100 and the base device 200 implemented without a chassis.

In aspects, the expansion device 100 and the base device 200 implemented as two modules when connected are ruggedized as defined herein. Further, implementation of the plurality of mechanical connectors 104 of the expansion device 100 and the plurality of mechanical connectors 204 of the base device 200 may include implementation where one may be floating to provide some tolerance when the two modules (the expansion device 100 and the base device 200) connect and the interfaces also need to connect.

Further, implementation of the plurality of mechanical connectors 104 of the expansion device 100 and the plurality of mechanical connectors 204 of the base device 200 may implement a physical connection of the modules. In aspects, the plurality of mechanical connectors 104 of the expansion device 100 and the plurality of mechanical connectors 204 of the base device 200 may be facilitated by castle connectors.

Further, implementation of the plurality of mechanical connectors 104 of the expansion device 100 and the plurality of mechanical connectors 204 of the base device 200 may include configurations where the external expansion interface when connected is sealed. In aspects, implementation of the plurality of mechanical connectors 104 of the expansion device 100 and the plurality of mechanical connectors 204 of the base device 200 may include configurations where when the expansion interface 102 and the expansion interface 202 are connected they are sealed to limit damage to the external expansion interface and/or interference with external expansion interface.

In aspects, the expansion device 100 may be implemented with a seal 122 to cover the expansion interface 102 as illustrated in FIG. 3. In aspects, the seal 122 may be configured to seal and/or protect the expansion interface 102 from interference and damage when the expansion device 100 is not connected to the base device 200.

With further reference to FIG. 1, the expansion device 100 may include a housing 106 having an upper housing surface 108, a plurality of side surfaces 110, a front surface 112, and a bottom surface 114. In aspects, the plurality of side surfaces 110 may extend from the upper housing surface 108 to the bottom surface 114.

In aspects, the seal 122 may include an attachment mechanism for attachment of the seal 122 to the expansion device 100. In aspects, the attachment mechanism may include a lanyard that is fastened to the upper housing surface 108 of the expansion device 100.

In aspects of the expansion device 100 illustrated in FIG. 1, the front surface 112 may include a plurality of electrical connectors 116 for connecting the expansion device 100 to other components. The plurality of electrical connectors 116 may connect to components within the expansion device 100 and the plurality of electrical connectors 116.

In aspects of the expansion device 100 illustrated in FIG. 2, the expansion device 100 may be configured on the front surface 112 to implement a plurality of components 118. The plurality of components 118 may connect to components within the expansion device 100 and the plurality of components 118 may be configured [# please provide a more detailed description of the plurality of components 118].

Referring back to FIG. 1, FIG. 2, and FIG. 4, the base device 200 may include a housing 206 having an upper housing surface 208, a plurality of side surfaces 210, a front surface 212, and a bottom surface 214. In aspects, the plurality of side surfaces 210 may extend from the upper housing surface 208 to the bottom surface 214.

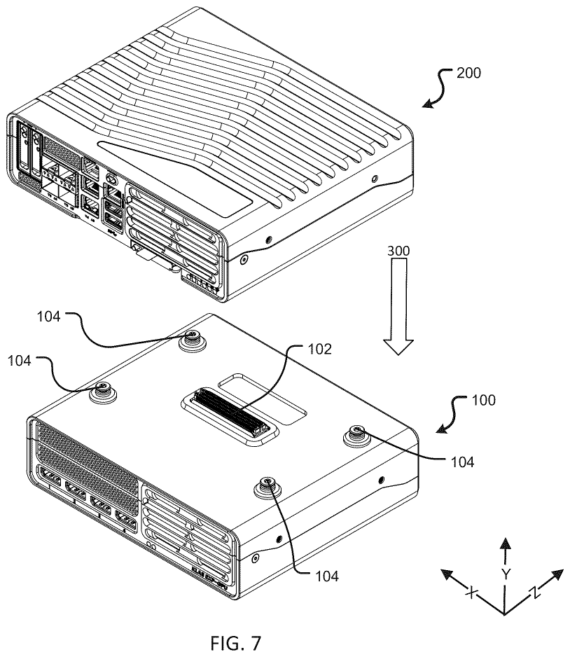

FIG. 7 illustrates a perspective view of the expansion device and the base device prior to connection according to aspects of the disclosure.

In particular, FIG. 7 illustrates a perspective view of the expansion device 100 and the base device 200 prior to connection according to aspects of the disclosure. In this regard, the base device 200 may be lowered in the direction of arrow 300 onto the expansion device 100. Lowering the base device 200 onto the expansion device 100 may align the plurality of mechanical connectors 104 with corresponding implementations of the plurality of mechanical connectors 204 arranged on the base device 200. Additionally, lowering the base device 200 onto the expansion device 100 may align the expansion interface 102 with corresponding a corresponding implementation of the expansion interface 202 arranged on the base device 200.

Referring to FIG. 4 and FIG. 5, in aspects, the plurality of mechanical connectors 204 of the base device 200 may have a locked configuration and an unlocked configuration. In aspects, the base device 200 may include a lock operation button 220. Operation of the lock operation button 220 by a user may place the plurality of mechanical connectors 204 in a locked configuration and/or an unlocked configuration.

In this regard, the user may manipulate the lock operation button 220 to configure the plurality of mechanical connectors 204 to be in the unlocked configuration while attaching the base device 200 to the expansion device 100. Thereafter, the user may push the base device 200 onto the top of the expansion device 100 in the direction of arrow 300 while aligning the plurality of mechanical connectors 104 of the expansion device 100 with the plurality of mechanical connectors 204 of the base device 200. Further, aligning the plurality of mechanical connectors 104 of the expansion device 100 with the plurality of mechanical connectors 204 of the base device 200 may likewise align the expansion interface 102 of the expansion device 100 with the expansion interface 202 of the base device 200. Once the base device 200 is fully vertically pressed down onto the top of the expansion device 100, a mechanical connection may be formed between the plurality of mechanical connectors 104 of the expansion device 100 and the plurality of mechanical connectors 204 of the base device 200; and an electrical connection may be formed between the expansion interface 102 of the expansion device 100 and the expansion interface 202 of the base device 200. Thereafter, the user can release the lock operation button 220 and the plurality of mechanical connectors 204 may be locked onto the plurality of mechanical connectors 104.

In aspects, the plurality of mechanical connectors 204 may be implemented as always locked. Accordingly, manipulation of the lock operation button 220 may place the plurality of mechanical connectors 204 in the unlocked configuration. In this regard, the user may manipulate the lock operation button 220 to configure the plurality of mechanical connectors 204 to be in the unlocked configuration while attaching the base device 200 to the expansion device 100. In aspects, releasing the lock operation button 220 may configure the plurality of mechanical connectors 204 back to the locked configuration. Likewise, the user may manipulate the lock operation button 220 to configure the plurality of mechanical connectors 204 to be in the unlocked configuration while removing the base device 200 from the expansion device 100.

In aspects, the base device 200 may be implemented with a seal 280 to cover the expansion interface 202 as illustrated in FIG. 5. In aspects, the seal 280 may be configured to seal and/or protect the expansion interface 202 from interference and damage when the base device 200 is not connected to the expansion device 100.

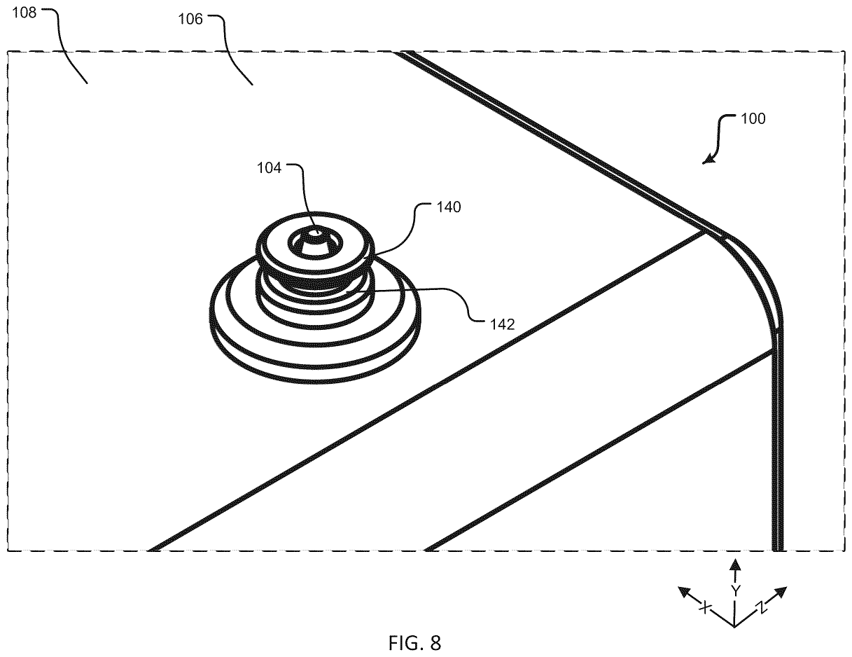

FIG. 8 illustrates a perspective view of the plurality of mechanical connectors according to aspects of the disclosure.

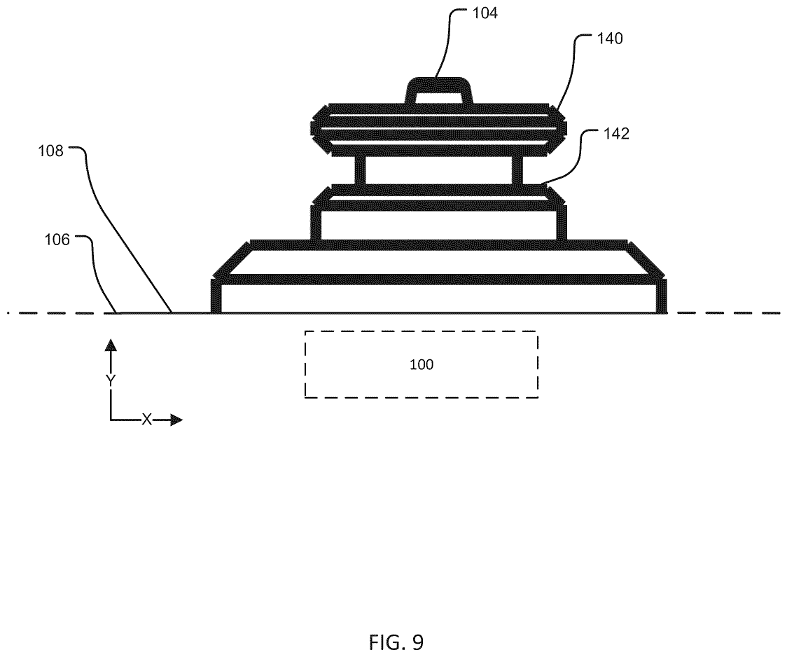

FIG. 9 illustrates a cross-sectional view of the plurality of mechanical connectors of FIG. 8.

In particular, FIG. 9 illustrates a cross-sectional view of the plurality of mechanical connectors 104 of FIG. 8. In aspects, the plurality of mechanical connectors 104 may be configured as a male mechanical fastener. In aspects, the plurality of mechanical connectors 104 may be configured as a castle connector.

In this regard, the plurality of mechanical connectors 104 may extend from the upper housing surface 108 of the expansion device 100 along the y-axis or vertical axis. In aspects, the plurality of mechanical connectors 104 may include a recess 142. As further described herein, the recess 142 of the plurality of mechanical connectors 104 may provide a locking functionality with the plurality of mechanical connectors 204 of the base device 200.

In aspects, the plurality of mechanical connectors 104 may include a chamfered surface 140. The chamfered surface 140 may guide and align the plurality of mechanical connectors 104 with the plurality of mechanical connectors 204 of the base device 200. Other configurations of the plurality of mechanical connectors 104 are contemplated as well.

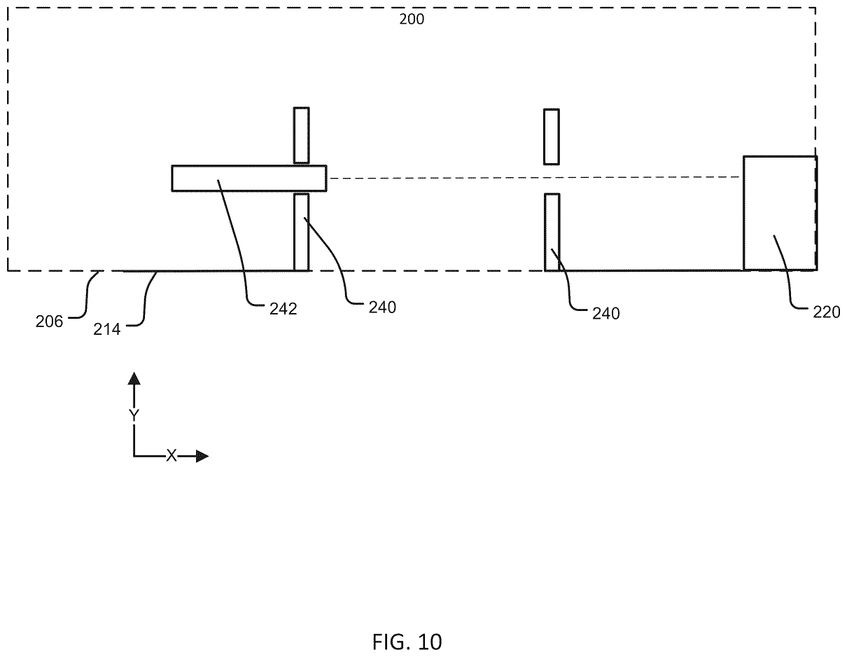

FIG. 10 illustrates a cross-sectional view of the base device with the plurality of mechanical connectors in a locked configuration according to aspects of the disclosure.

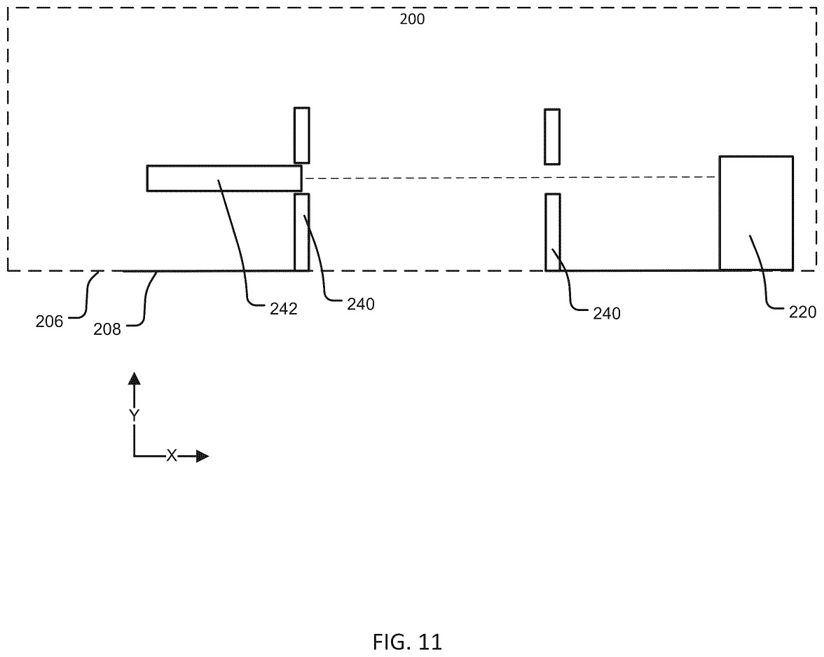

FIG. 11 illustrates a cross-sectional view of the base device with the plurality of mechanical connectors in an unlocked configuration according to aspects of the disclosure.

In particular, FIG. 10 illustrates a cross-sectional view of the base device 200 with the plurality of mechanical connectors 204 in a locked configuration according to aspects of the disclosure. The plurality of mechanical connectors 204 may be configured as a female connector configured to receive the plurality of mechanical connectors 104 of the expansion device 100. The plurality of mechanical connectors 204 may be arranged within the bottom surface 214 of the housing 206.

In aspects, the plurality of mechanical connectors 204 may include guide walls 240. In aspects, the guide walls 240 may guide the plurality of mechanical connectors 104 into the plurality of mechanical connectors 204.

Further, the plurality of mechanical connectors 204 may include a locking structure 242. The locking structure 242 may be positioned to extend between the guide walls 240 when locked as illustrated in FIG. 10; and the locking structure 242 may be positioned to be retracted from between the guide walls 240 when unlocked as illustrated in FIG. 11. In this regard, a position of the locking structure 242 may be responsive to a position of the lock operation button 220. For example, the locking structure 242 and the lock operation button 220 may be mechanically connected such that movement of the lock operation button 220 results in movement of the locking structure 242.

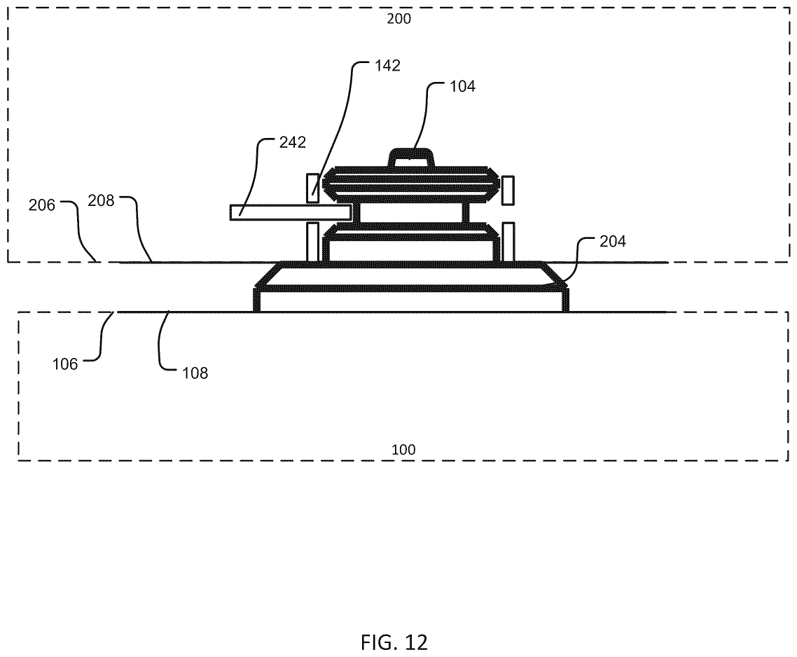

FIG. 12 illustrates a cross-sectional view of the expansion device and the base device with the plurality of mechanical connectors in a locked configuration according to aspects of the disclosure.

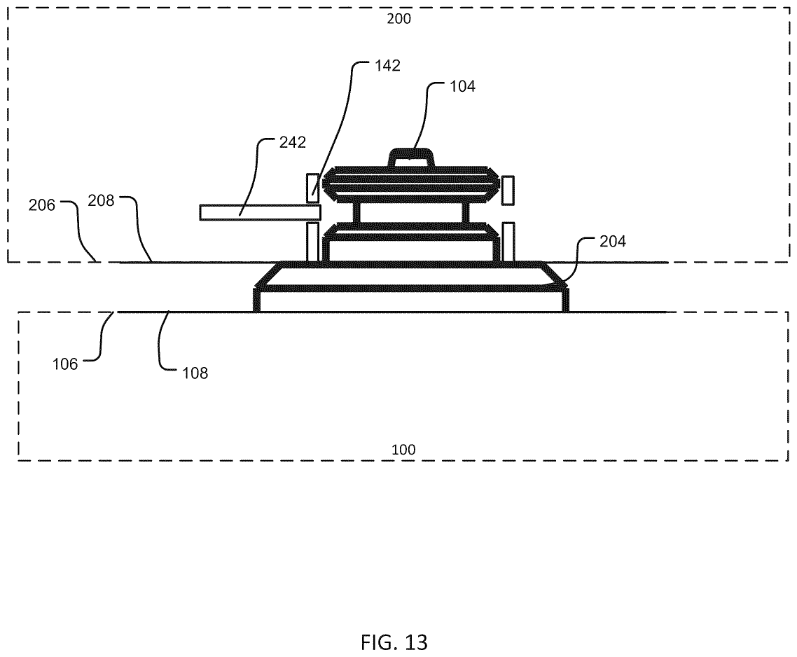

FIG. 13 illustrates a cross-sectional view of the expansion device and the base device with the plurality of mechanical connectors in an unlocked configuration according to aspects of the disclosure.

In particular, FIG. 12 illustrates a cross-sectional view of the expansion device 100 and the base device 200 with the plurality of mechanical connectors 204 in a locked configuration according to aspects of the disclosure. In this regard, the base device 200 is arranged on the expansion device 100 to form a combined set of modules. Further, the locking structure 242 of the plurality of mechanical connectors 204 has engaged the recess 142 of the plurality of mechanical connectors 104. Accordingly, the expansion device 100 and the base device 200 are locked together.

With reference to FIG. 13, the locking structure 242 has been moved laterally from the recess 142 of the plurality of mechanical connectors 104. Accordingly, the plurality of mechanical connectors 104 may be free to be removed from the plurality of mechanical connectors 204 and the expansion device 100 and the base device 200 may be separated. Additionally, when connecting the base device 200 to the expansion device 100, the locking structure 242 may again be manipulated to separate the locking structure 242 from the recess 142 so that the base device 200 may be connected to the expansion device 100.

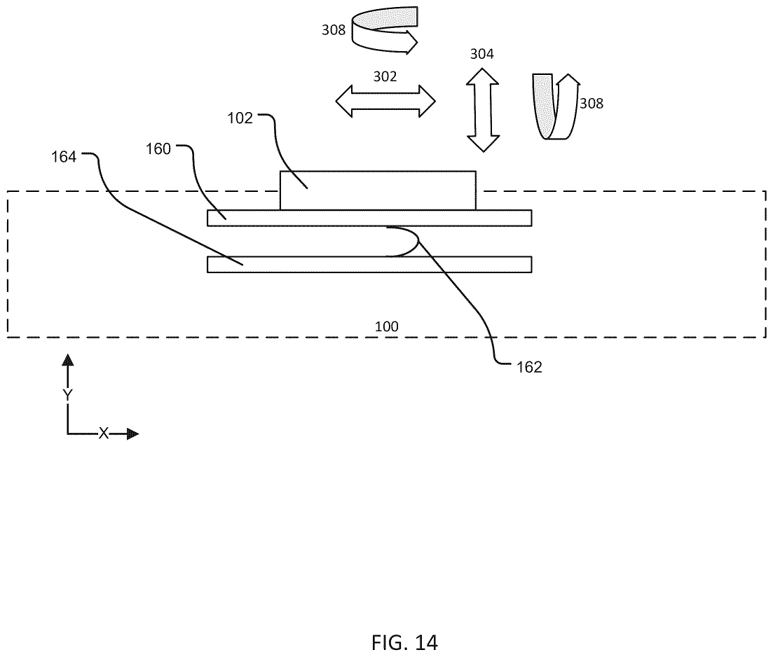

FIG. 14 illustrates a cross-sectional view of the expansion device and the expansion interface according to aspects of the disclosure.

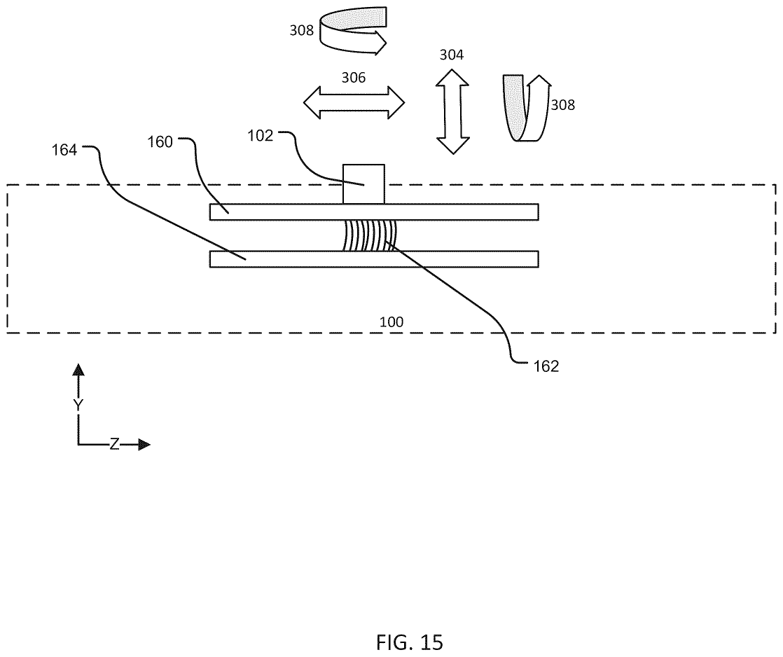

FIG. 15 illustrates another cross-sectional view of the expansion device and the expansion interface according to aspects of the disclosure.

In particular, FIG. 14 illustrates a cross-sectional view of the expansion device 100 and the expansion interface 102 according to aspects of the disclosure. In aspects, the expansion device 100 may include an interface printed circuit board 160 configured to support the expansion interface 102.

In particular, the interface printed circuit board 160 may be floating within the housing 106 of the expansion device 100 to provide movement of the interface printed circuit board 160 and the expansion interface 102 vertically along the y-axis. Accordingly, the expansion interface 102 may move with respect to the expansion device 100 in the direction of arrow 304.

Further, the interface printed circuit board 160 may be floating within the housing 106 of the expansion device 100 to provide movement of the interface printed circuit board 160 and the expansion interface 102 horizontally along the x-axis. Accordingly, the expansion interface 102 may move with respect to the expansion device 100 in the direction of arrow 302.

As illustrated in FIG. 15, the interface printed circuit board 160 may be floating within the housing 106 of the expansion device 100 to provide movement of the interface printed circuit board 160 and the expansion interface 102 horizontally along the z-axis. Accordingly, the expansion interface 102 may move with respect to the expansion device 100 in the direction of arrow 306.

Additionally, the interface printed circuit board 160 may be floating within the housing 106 of the expansion device 100 to provide rotational movement of the interface printed circuit board 160 and the expansion interface 102 about the y-axis, the x-axis, and/or the z-axis. Accordingly, the expansion interface 102 may rotate with respect to the expansion device 100 in one or more of the directions of arrows 308.

Additionally, the expansion interface 102 and/or the interface printed circuit board 160 may be connected to the nonmoving components within the expansion device 100 such as a circuit board 164. In aspects, the expansion interface 102 and/or the interface printed circuit board 160 may be connected to the circuit board 164 with a flexible electrical connection 162 configured to transfer data and/or signals. In aspects, the flexible electrical connection 162 may include one or more flexible physical mediums, wires, cables, ribbon cables, flat cables, flexible flat cables, and/or the like and may include one or more electrical connectors, micro connectors, miniature ribbon connectors, ribbon connectors, and/or the like.

Accordingly, the expansion interface 102 may move with respect to the expansion device 100 in the direction of arrow 304, the expansion interface 102 may move with respect to the expansion device 100 in the direction of arrow 302, the expansion interface 102 may move with respect to the expansion device 100 in the direction of arrow 306 and/or the expansion interface 102 may rotate with respect to the expansion device 100 in the directions of one or more of the arrows 308. In aspects, the expansion interface 102 may move up to 360°with respect to the expansion device 100.

In aspects, the flexible electrical connection 162 may provide a certain degree of elastic support, spring-like support, and/or the like to the interface printed circuit board 160 to provide limited movement of the interface printed circuit board 160 and the expansion interface 102 as described herein. However, other configurations are contemplated as well.

In aspects, the expansion interface 102 and/or the interface printed circuit board 160 may be configured within the housing 106 with a configuration to allow limited movement of the expansion interface 102 and/or the interface printed circuit board 160. In aspects, the configuration to allow limited movement of the expansion interface 102 and/or the interface printed circuit board 160 may be implemented with a limited space to both allow movement and constrain movement of the expansion interface 102 and/or the interface printed circuit board 160.

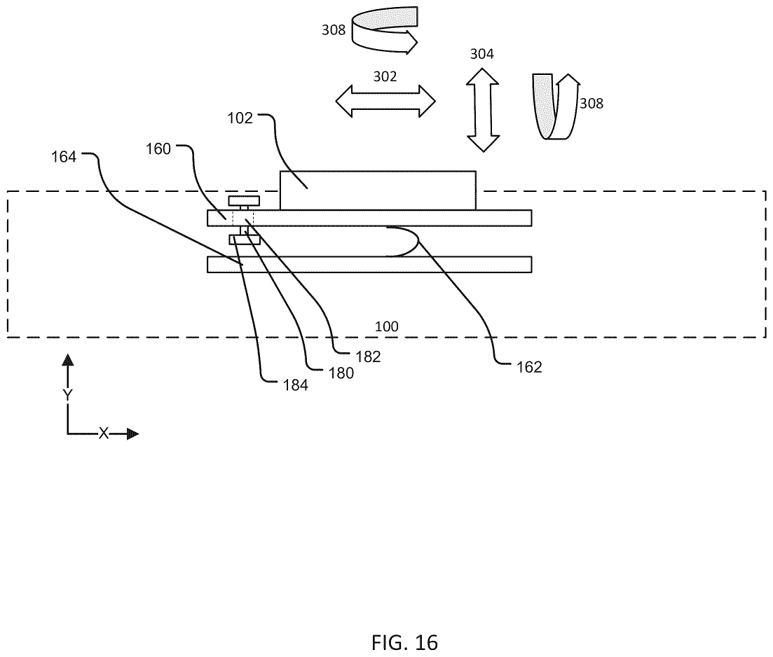

FIG. 16 illustrates a cross-sectional view of a particular implementation of the expansion device and the expansion interface according to aspects of the disclosure.

As illustrated in FIG. 16, the configuration to allow limited movement of the expansion interface 102 and/or the interface printed circuit board 160 may be implemented with a pin 180 and an aperture 182. The pin 180 may be supported within the expansion device 100 and may extend within the housing 106 along an axis, such as the y-axis illustrated in FIG. 16.

Further, the interface printed circuit board 160 and/or the expansion interface 102 may include the aperture 182. The aperture 182 may have a diameter greater than the diameter of the pin 180. The pin 180 may extend through the aperture 182 and allow for movement of the interface printed circuit board 160 and/or the expansion interface 102 with respect to the pin 180. In aspects, the pin 180 may be configured as a fastener, such as a screw, bolt, rivet, and/or the like.

Further, the pin 180 and the aperture 182 may be sized, configured, and/or the like to allow the expansion interface 102 to move with respect to the expansion device 100 in the direction of the arrow 304, the arrow 302, the arrow 306 and/or rotate in the directions of one or more of the arrows 308.

Additionally, the pin 180 may be configured with a portion 184 having a diameter and/or size greater than a diameter of the aperture 182. In aspects, the portion 184 may limit movement of the interface printed circuit board 160 along the y-axis. In aspects, the portion 184 may limit movement of the interface printed circuit board 160 along the y-axis but also allow the expansion interface 102 to move with respect to the expansion device 100 in the direction of the arrow 304, the arrow 302, the arrow 306 and/or rotate in the directions of one or more of the arrows 308.

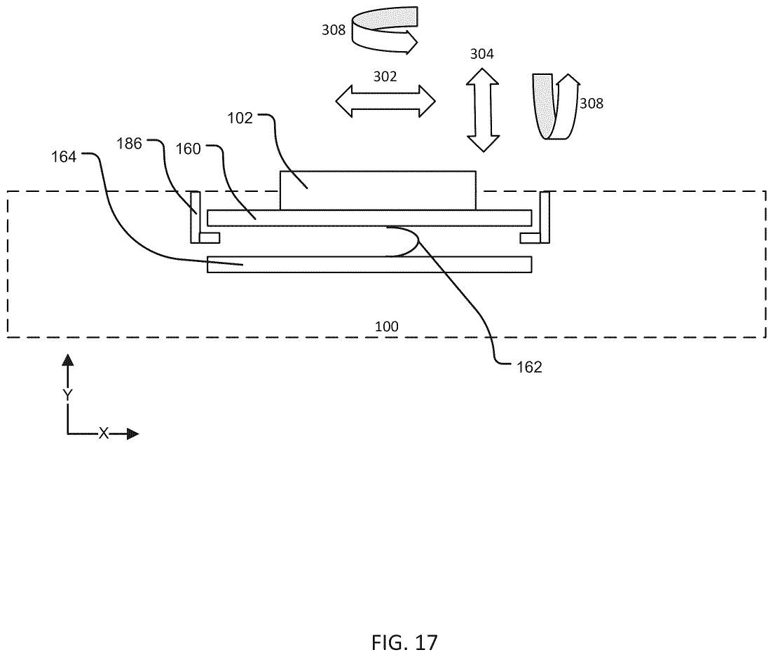

FIG. 17 illustrates a cross-sectional view of a particular implementation of the expansion device and the expansion interface according to aspects of the disclosure.

In other aspects, the configuration to allow limited movement of the expansion interface 102 and/or the interface printed circuit board 160 may be implemented to include one or more walls 186 arranged within the housing 106 to both allow movement and constrain movement of the expansion interface 102 and/or the interface printed circuit board 160. However, other configurations are contemplated as well. In aspects, the one or more walls 186 may allow the expansion interface 102 to move with respect to the expansion device 100 in the direction of the arrow 304, the arrow 302, the arrow 306 and/or rotate in the directions of one or more of the arrows 308.

Referring back to FIG. 4, in aspects the base device 200 may include a configuration 252 to receive SSD (Solid-state drive) devices that may be configured as high-speed storage devices. In aspects, the SSD devices may be E.1 form factor.

In aspects, the base device 200 may include networking ports 254. In aspects, the networking ports 254 may be Small Form-factor Pluggable (SFP) type ports. In aspects, the networking ports 254 may be ganged together to provide increased bandwidth.

In aspects, the base device 200 may include networking ports 256. In aspects, the networking ports 256 may be RJ45 networking ports. In aspects, the base device 200 may include a console connector 258 for connecting to a console to obtain information on implementation of the base device 200.

In aspects, the base device 200 may include a power switch 260 configured to control power delivery to the component of the base device 200.

In aspects, the base device 200 may include a data management port 262. In aspects, the data management port 262 may be configured to allow interaction by user to load software, obtain status information, and/or the like.

In aspects, the base device 200 may include USB ports 264. The USB ports 264 may be utilized to provide connections to peripheral devices, connection to storage devices, and/or the like. In aspects, the base device 200 may include an Megaport Virtual Edge (MVE) device port 268.

In aspects, the base device 200 may further include a cooling system 270 that may include vents, fans, and/or the like to provide active cooling for the base device 200.

In aspects, the base device 200 may include status lights 272. In aspects, the status lights 272 may provide insight into aspects of the base device 200 including status of power, Wi-Fi connectivity, temperature, battery level, security, and/or the like.

In aspects, the base device 200 may implement a cover on the plurality of mechanical connectors 204 such that the plurality of mechanical connectors 204 is not exposed to the environment. When it is desired to connect the base device 200 by the plurality of mechanical connectors 204 to the expansion interface 102 of the expansion device 100, the cover may be removed for such connection.

In aspects, the expansion device 100 may be implemented as a graphics processing unit (GPU). In aspects, the GPU implementation of the expansion device 100 may be configured to accelerate computer graphics and image processing in conjunction with the base device 200 and/or for the base device 200. In aspects, the GPU implementation of the expansion device 100 may be configured with a video card and/or the like configured to implement the GPU functionality of the expansion device 100.

In aspects, the expansion device 100 may be implemented as a data storage unit. In aspects, the data storage unit implementation of the expansion device 100 may be configured to provide data storage in conjunction with the base device 200 and/or for the base device 200. In aspects, the data storage unit implementation of the expansion device 100 may be implemented with a redundant array of independent disks (RAID) configuration. In aspects, the RAID implementation of the expansion device 100 may include implementation of any RAID Standard levels, such as RAID 0, RAID 1, RAID 2, RAID 3, RAID 4, RAID 5, RAID 6, and/or the like.

As described herein, aspects of the expansion device 100 and associated components and the base device 200 and associated components are described as being rugged, ruggedized, and/or the like hereinafter referred to as “ruggedized.” In this regard, ruggedized relates to the expansion device 100 and associated components and the base device 200 and associated components being configured to be hard-wearing, configured to be shock-resistant, and/or the like.

Further, ruggedized relates to the expansion device 100 and associated components and the base device 200 and associated components being configured for implementations in environments that include above-average exposure to and/or above-average extremes of shock, vibration, temperature, humidity, corrosion, abrasion, noise, pressure, altitude, electromagnetic interference, and/or the like.

Further, ruggedized relates to the expansion device 100 and associated components and the base device 200 and associated components being configured to be used in military applications, configured for battlefield implementations, configured for public safety, configured for field sales, configured for field service, configured for manufacturing, configured for retail, configured for healthcare, configured for construction, configured for transportation, configured for distribution, and/or the like. Further, ruggedized relates to the expansion device 100 and associated components and the base device 200 and associated components being configured in compliance with MIL-STD-810, MIL-STD-810G CN1 (2014), MIL-STD-461, MIL-S-901, and/or the like.

One EXAMPLE: an expansion device includes an expansion interface. The expansion device in addition includes a plurality of mechanical connectors. The expansion device moreover includes where the expansion interface of the expansion device is configured to electrically connect to a base device in order to exchange data and/or signals between the expansion device and the base device. The expansion device also includes where the plurality of mechanical connectors of the expansion device are configured to mechanically connect the expansion device to the base device in order to provide a combined configuration of the expansion device and the base device.

The above-noted EXAMPLE may further include any one or a combination of more than one of the following EXAMPLES: The expansion device of the above-noted EXAMPLE where the plurality of mechanical connectors are configured to ensure alignment of the expansion interface with a corresponding interface on the base device. The expansion device of the above-noted EXAMPLE where the expansion interface is configured as a high speed interface and/or high-speed interconnect; and where the base device is configured with the expansion interface configured as a high speed interface and/or high-speed interconnect. The expansion device of the above-noted EXAMPLE where the expansion interface is configured to move with respect to the expansion device in at least two directions. The expansion device of the above-noted EXAMPLE where the expansion interface is configured to move with respect to the expansion device in three directions. The expansion device of the above-noted EXAMPLE where the expansion interface is configured to float with respect to the expansion device in at least two directions. The expansion device of the above-noted EXAMPLE where the expansion interface is configured to float with respect to the expansion device in three directions. The expansion device of the above-noted EXAMPLE where the expansion interface is configured to rotate with respect to the expansion device in at least one direction. The expansion device of the above-noted EXAMPLE where the base device comprises an expansion interface and a plurality of mechanical connectors. The expansion device of the above-noted EXAMPLE where the expansion device and the base device are configured to have a small form factor, a light weight, and also further configured to be rugged for implementation in harsh environments. The expansion device of the above-noted EXAMPLE where the expansion device and the base device are configured to have a small form factor and a light weight. The expansion device of the above-noted EXAMPLE where the expansion device and the base device are configured to be rugged for implementation in harsh environments. The expansion device of the above-noted EXAMPLE where the expansion device is configured with additional computer functionality, computer components, graphics components, processing devices, storage, switch devices, networking devices, and/or routing devices. The expansion device of the above-noted EXAMPLE where the expansion interface is configured as a floating connector. The expansion device of the above-noted EXAMPLE where the expansion interface avoids a need for a wired connection from a port of the expansion device to a port of the base device. The expansion device of the above-noted EXAMPLE where the expansion interface of the expansion device and the expansion interface of the base device are configured as a Peripheral Component Interconnect Express (PCIe) interface. The expansion device of the above-noted EXAMPLE where the plurality of mechanical connectors of the expansion device and the plurality of mechanical connectors of the base device are configured as castle connectors. The expansion device of the above-noted EXAMPLE where the plurality of mechanical connectors of the expansion device and the plurality of mechanical connectors of the base device comprise configurations where an external expansion interface when connected is sealed to limit damage to the external expansion interface and/or limit interference with the external expansion interface. The expansion device of the above-noted EXAMPLE includes a seal configured to seal and/or protect the expansion interface from interference and damage when the expansion device is not connected to the base device. The expansion device of the above-noted EXAMPLE includes a lock operation button configured to allow a user to manipulate and configure the plurality of mechanical connectors to be in an unlocked configuration while attaching the base device to the expansion device. The expansion device of the above-noted EXAMPLE where aligning the plurality of mechanical connectors of the expansion device with the plurality of mechanical connectors of the base device likewise aligns the expansion interface of the expansion device with the expansion interface of the base device. The expansion device of the above-noted EXAMPLE where the plurality of mechanical connectors of the base device have a locked configuration and an unlocked configuration; where the base device comprises a lock operation button; and where operation of the lock operation button by a user places the plurality of mechanical connectors in a locked configuration and/or an unlocked configuration. The expansion device of the above-noted EXAMPLE where the plurality of mechanical connectors comprise male connector. The expansion device of the above-noted EXAMPLE where the plurality of mechanical connectors of the base device are configured as a female connector configured to receive the plurality of mechanical connectors of the expansion device. The expansion device of the above-noted EXAMPLE where the plurality of mechanical connectors of the base device are arranged within a bottom surface of a housing of the base device. The expansion device of the above-noted EXAMPLE where the plurality of mechanical connectors comprise a recess configured to provide a locking functionality with the plurality of mechanical connectors of the base device. The expansion device of the above-noted EXAMPLE where the plurality of mechanical connectors of the base device comprise guide walls guide the plurality of mechanical connectors into the plurality of mechanical connectors. The expansion device of the above-noted EXAMPLE where the plurality of mechanical connectors of the base device comprise a locking structure to engage the recess of the plurality of mechanical connectors. The expansion device of the above-noted EXAMPLE includes an interface printed circuit board configured to support the expansion interface. The expansion device of the above-noted EXAMPLE where the interface printed circuit board comprises a flexible electrical connection configured to connect the interface printed circuit board to components within the expansion device. The expansion device of the above-noted EXAMPLE where there are four implementations of the plurality of mechanical connectors. The expansion device of the above-noted EXAMPLE where the base device comprises a virtual machine and/or a server. The expansion device of the above-noted EXAMPLE where the expansion device and the base device are configured for implementation in a nineteen inch rack.

One EXAMPLE: an expansion device includes an expansion interface. The expansion device in addition includes a plurality of mechanical connectors. The expansion device moreover includes where the expansion interface of the expansion device is configured to electrically connect to a base device in order to exchange data and/or signals between the expansion device and the base device. The expansion device also includes where the plurality of mechanical connectors of the expansion device are configured to mechanically connect the expansion device to the base device in order to provide a combined configuration of the expansion device and the base device. The expansion device further includes where the expansion interface is configured to move with respect to the expansion device in at least two directions.

The above-noted EXAMPLE may further include any one or a combination of more than one of the following EXAMPLES: The expansion device of the above-noted EXAMPLE where the plurality of mechanical connectors are configured to ensure alignment of the expansion interface with a corresponding interface on the base device. The expansion device of the above-noted EXAMPLE where the expansion interface is configured to move with respect to the expansion device in three directions. The expansion device of the above-noted EXAMPLE where the expansion interface is configured to float with respect to the expansion device in at least two directions. The expansion device of the above-noted EXAMPLE where the expansion interface is configured to float with respect to the expansion device in three directions. The expansion device of the above-noted EXAMPLE where the expansion interface is configured to rotate with respect to the expansion device in at least one direction. The expansion device of the above-noted EXAMPLE where the base device comprises an expansion interface and a plurality of mechanical connectors. The expansion device of the above-noted EXAMPLE where the expansion device and the base device are configured to have a small form factor, a light weight, and also further configured to be rugged for implementation in harsh environments. The expansion device of the above-noted EXAMPLE where the expansion device and the base device are configured for implementation in a nineteen inch rack. The expansion device of the above-noted EXAMPLE where the expansion device is configured with additional computer functionality, computer components, graphics components, processing devices, storage, switch devices, networking devices, and/or routing devices. The expansion device of the above-noted EXAMPLE where the expansion interface is configured as a high speed interface and/or high-speed interconnect; and the base device is configured with the expansion interface configured as a high speed interface and/or high-speed interconnect. The expansion device of the above-noted EXAMPLE where the expansion interface is configured as a floating connector. The expansion device of the above-noted EXAMPLE where the expansion interface avoids a need to implement wired connections between the expansion device and the base device. The expansion device of the above-noted EXAMPLE where the expansion interface of the expansion device and the expansion interface of the base device are configured as a Peripheral Component Interconnect Express (PCIe) interface. The expansion device of the above-noted EXAMPLE where the plurality of mechanical connectors of the expansion device and the plurality of mechanical connectors of the base device are configured as castle connectors. The expansion device of the above-noted EXAMPLE where the plurality of mechanical connectors of the expansion device and the plurality of mechanical connectors of the base device comprise configurations where an external expansion interface when connected is sealed. The expansion device of the above-noted EXAMPLE includes a lock operation button configured to allow a user to manipulate and configure the plurality of mechanical connectors to be in an unlocked configuration while attaching the base device to the expansion device. The expansion device of the above-noted EXAMPLE where aligning the plurality of mechanical connectors of the expansion device with the plurality of mechanical connectors of the base device likewise aligns the expansion interface of the expansion device with the expansion interface of the base device. The expansion device of the above-noted EXAMPLE where the plurality of mechanical connectors of the base device have a locked configuration and an unlocked configuration; where the base device comprises a lock operation button; and where operation of the lock operation button by a user places the plurality of mechanical connectors in a locked configuration and/or an unlocked configuration. The expansion device of the above-noted EXAMPLE where the plurality of mechanical connectors comprise male connector. The expansion device of the above-noted EXAMPLE where the plurality of mechanical connectors of the base device are configured as a female connector configured to receive the plurality of mechanical connectors of the expansion device. The expansion device of the above-noted EXAMPLE where the plurality of mechanical connectors of the base device are arranged within a bottom surface of a housing of the base device. The expansion device of the above-noted EXAMPLE where the plurality of mechanical connectors comprise a recess configured to provide a locking functionality with the plurality of mechanical connectors of the base device. The expansion device of the above-noted EXAMPLE where the plurality of mechanical connectors of the base device comprise guide walls guide the plurality of mechanical connectors into the plurality of mechanical connectors. The expansion device of the above-noted EXAMPLE where the plurality of mechanical connectors of the base device comprise a locking structure to engage the recess of the plurality of mechanical connectors. The expansion device of the above-noted EXAMPLE includes a printed circuit board configured to support the expansion interface. The expansion device of the above-noted EXAMPLE where the printed circuit board comprises a flexible electrical connection. The expansion device of the above-noted EXAMPLE where there are four implementations of the plurality of mechanical connectors. The expansion device of the above-noted EXAMPLE where the base device comprises a virtual machine and/or a server.

One EXAMPLE: a system includes a base device. The system in addition includes an expansion device comprising an expansion interface and a plurality of mechanical connectors. The system moreover includes where the expansion interface of the expansion device is configured to electrically connect to the base device in order to exchange data and/or signals between the expansion device and the base device. The system also includes where the plurality of mechanical connectors of the expansion device are configured to mechanically connect the expansion device to the base device in order to provide a combined configuration of the expansion device and the base device.

The above-noted EXAMPLE may further include any one or a combination of more than one of the following EXAMPLES: The system of the above-noted EXAMPLE where the plurality of mechanical connectors are configured to ensure alignment of the expansion interface with a corresponding interface on the base device. The system of the above-noted EXAMPLE where the expansion interface is configured as a high speed interface and/or high-speed interconnect; and where the base device is configured with the expansion interface configured as a high speed interface and/or high-speed interconnect. The system of the above-noted EXAMPLE where the expansion interface is configured to move with respect to the expansion device in at least two directions. The system of the above-noted EXAMPLE where the expansion interface is configured to move with respect to the expansion device in three directions. The system of the above-noted EXAMPLE where the expansion interface is configured to float with respect to the expansion device in at least two directions. The system of the above-noted EXAMPLE where the expansion interface is configured to float with respect to the expansion device in three directions. The system of the above-noted EXAMPLE where the expansion interface is configured to rotate with respect to the expansion device in at least one direction. The system of the above-noted EXAMPLE where the base device comprises an expansion interface and a plurality of mechanical connectors. The system of the above-noted EXAMPLE where the expansion device and the base device are configured to have a small form factor, a light weight, and also further configured to be rugged for implementation in harsh environments. The system of the above-noted EXAMPLE where the expansion device and the base device are configured to have a small form factor and a light weight. The system of the above-noted EXAMPLE where the expansion device and the base device are configured to be rugged for implementation in harsh environments. The system of the above-noted EXAMPLE where the expansion device is configured with additional computer functionality, computer components, graphics components, processing devices, storage, switch devices, networking devices, and/or routing devices. The system of the above-noted EXAMPLE where the expansion interface is configured as a floating connector. The system of the above-noted EXAMPLE where the expansion interface avoids a need for a wired connection from a port of the expansion device to a port of the base device. The system of the above-noted EXAMPLE where the expansion interface of the expansion device and the expansion interface of the base device are configured as a Peripheral Component Interconnect Express (PCIe) interface. The system of the above-noted EXAMPLE where the plurality of mechanical connectors of the expansion device and the plurality of mechanical connectors of the base device are configured as castle connectors. The system of the above-noted EXAMPLE where the plurality of mechanical connectors of the expansion device and the plurality of mechanical connectors of the base device comprise configurations where an external expansion interface when connected is sealed to limit damage to the external expansion interface and/or limit interference with the external expansion interface. The system of the above-noted EXAMPLE includes a seal configured to seal and/or protect the expansion interface from interference and damage when the expansion device is not connected to the base device. The system of the above-noted EXAMPLE includes a lock operation button configured to allow a user to manipulate and configure the plurality of mechanical connectors to be in an unlocked configuration while attaching the base device to the expansion device. The system of the above-noted EXAMPLE where aligning the plurality of mechanical connectors of the expansion device with the plurality of mechanical connectors of the base device likewise aligns the expansion interface of the expansion device with the expansion interface of the base device. The system of the above-noted EXAMPLE where the plurality of mechanical connectors of the base device have a locked configuration and an unlocked configuration; where the base device comprises a lock operation button; and where operation of the lock operation button by a user places the plurality of mechanical connectors in a locked configuration and/or an unlocked configuration. The system of the above-noted EXAMPLE where the plurality of mechanical connectors comprise male connector. The system of the above-noted EXAMPLE where the plurality of mechanical connectors of the base device are configured as a female connector configured to receive the plurality of mechanical connectors of the expansion device. The system of the above-noted EXAMPLE where the plurality of mechanical connectors of the base device are arranged within a bottom surface of a housing of the base device. The system of the above-noted EXAMPLE where the plurality of mechanical connectors comprise a recess configured to provide a locking functionality with the plurality of mechanical connectors of the base device. The system of the above-noted EXAMPLE where the plurality of mechanical connectors of the base device comprise guide walls guide the plurality of mechanical connectors into the plurality of mechanical connectors. The system of the above-noted EXAMPLE where the plurality of mechanical connectors of the base device comprise a locking structure to engage the recess of the plurality of mechanical connectors. The system of the above-noted EXAMPLE includes an interface printed circuit board configured to support the expansion interface. The system of the above-noted EXAMPLE where the interface printed circuit board comprises a flexible electrical connection configured to connect the interface printed circuit board to components within the expansion device. The system of the above-noted EXAMPLE where there are four implementations of the plurality of mechanical connectors. The system of the above-noted EXAMPLE where the base device comprises a virtual machine and/or a server. The system of the above-noted EXAMPLE where the expansion device and the base device are configured for implementation in a nineteen inch rack.

One EXAMPLE: a system includes a base device. The system in addition includes an expansion device comprising an expansion interface and a plurality of mechanical connectors. The system moreover includes where the expansion interface of the expansion device is configured to electrically connect to the base device in order to exchange data and/or signals between the expansion device and the base device. The system also includes where the plurality of mechanical connectors of the expansion device are configured to mechanically connect the expansion device to the base device in order to provide a combined configuration of the expansion device and the base device. The system further includes where the expansion interface is configured to move with respect to the expansion device in at least two directions.

The above-noted EXAMPLE may further include any one or a combination of more than one of the following EXAMPLES: The system of the above-noted EXAMPLE where the plurality of mechanical connectors are configured to ensure alignment of the expansion interface with a corresponding interface on the base device. The system of the above-noted EXAMPLE where the expansion interface is configured to move with respect to the expansion device in three directions. The system of the above-noted EXAMPLE where the expansion interface is configured to float with respect to the expansion device in at least two directions. The system of the above-noted EXAMPLE where the expansion interface is configured to float with respect to the expansion device in three directions. The system of the above-noted EXAMPLE where the expansion interface is configured to rotate with respect to the expansion device in at least one direction. The system of the above-noted EXAMPLE where the base device comprises an expansion interface and a plurality of mechanical connectors. The system of the above-noted EXAMPLE where the expansion device and the base device are configured to have a small form factor, a light weight, and also further configured to be rugged for implementation in harsh environments. The system of the above-noted EXAMPLE where the expansion device and the base device are configured for implementation in a nineteen inch rack. The system of the above-noted EXAMPLE where the expansion device is configured with additional computer functionality, computer components, graphics components, processing devices, storage, switch devices, networking devices, and/or routing devices. The system of the above-noted EXAMPLE where the expansion interface is configured as a high speed interface and/or high-speed interconnect; and the base device is configured with the expansion interface configured as a high speed interface and/or high-speed interconnect. The system of the above-noted EXAMPLE where the expansion interface is configured as a floating connector. The system of the above-noted EXAMPLE where the expansion interface avoids a need to implement wired connections between the expansion device and the base device. The system of the above-noted EXAMPLE where the expansion interface of the expansion device and the expansion interface of the base device are configured as a Peripheral Component Interconnect Express (PCIe) interface. The system of the above-noted EXAMPLE where the plurality of mechanical connectors of the expansion device and the plurality of mechanical connectors of the base device are configured as castle connectors. The system of the above-noted EXAMPLE where the plurality of mechanical connectors of the expansion device and the plurality of mechanical connectors of the base device comprise configurations where an external expansion interface when connected is sealed. The system of the above-noted EXAMPLE includes a lock operation button configured to allow a user to manipulate and configure the plurality of mechanical connectors to be in an unlocked configuration while attaching the base device to the expansion device. The system of the above-noted EXAMPLE where aligning the plurality of mechanical connectors of the expansion device with the plurality of mechanical connectors of the base device likewise aligns the expansion interface of the expansion device with the expansion interface of the base device. The system of the above-noted EXAMPLE where the plurality of mechanical connectors of the base device have a locked configuration and an unlocked configuration; where the base device comprises a lock operation button; and where operation of the lock operation button by a user places the plurality of mechanical connectors in a locked configuration and/or an unlocked configuration. The system of the above-noted EXAMPLE where the plurality of mechanical connectors comprise male connector. The system of the above-noted EXAMPLE where the plurality of mechanical connectors of the base device are configured as a female connector configured to receive the plurality of mechanical connectors of the expansion device. The system of the above-noted EXAMPLE where the plurality of mechanical connectors of the base device are arranged within a bottom surface of a housing of the base device. The system of the above-noted EXAMPLE where the plurality of mechanical connectors comprise a recess configured to provide a locking functionality with the plurality of mechanical connectors of the base device. The system of the above-noted EXAMPLE where the plurality of mechanical connectors of the base device comprise guide walls guide the plurality of mechanical connectors into the plurality of mechanical connectors. The system of the above-noted EXAMPLE where the plurality of mechanical connectors of the base device comprise a locking structure to engage the recess of the plurality of mechanical connectors. The system of the above-noted EXAMPLE includes a printed circuit board configured to support the expansion interface. The system of the above-noted EXAMPLE where the printed circuit board comprises a flexible electrical connection. The system of the above-noted EXAMPLE where there are four implementations of the plurality of mechanical connectors. The system of the above-noted EXAMPLE where the base device comprises a virtual machine and/or a server.

Accordingly, the disclosure has set forth an improved connection between a base device and an expansion device.

As may be appreciated by those skilled in the art, the illustrated structure is a logical structure and not a physical one. Accordingly, the illustrated modules can be implemented by employing various hardware and software components. In addition, two or more of the logical components can be implemented as a single module that provides functionality for both components. In one aspect, the components are implemented as software program modules.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto another element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over another element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to another element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Aspects of the disclosure may include a server executing an instance of an application or software configured to accept requests from a client and giving responses accordingly. The server may run on any computer including dedicated computers. The computer may include at least one processing element, typically a central processing unit (CPU), and some form of memory. The processing element may carry out arithmetic and logic operations, and a sequencing and control unit may change the order of operations in response to stored information. The server may include peripheral devices that may allow information to be retrieved from an external source, and the result of operations saved and retrieved. The server may operate within a client-server architecture. The server may perform some tasks on behalf of clients. The clients may connect to the server through the network on a communication channel as defined herein. The server may use memory with error detection and correction, redundant disks, redundant power supplies and so on.

The many features and advantages of the disclosure are apparent from the detailed specification, and, thus, it is intended by the appended claims to cover all such features and advantages of the disclosure which fall within the true spirit and scope of the disclosure. Further, since numerous modifications and variations will readily occur to those skilled in the art, it is not desired to limit the disclosure to the exact construction and operation illustrated and described, and, accordingly, all suitable modifications and equivalents may be resorted to that fall within the scope of the disclosure.

1. An expansion device comprising:
an expansion interface; and
a plurality of mechanical connectors,
wherein the expansion interface of the expansion device is configured to electrically connect to a base device in order to exchange data and/or signals between the expansion device and the base device; and
wherein the plurality of mechanical connectors of the expansion device are configured to mechanically connect the expansion device to the base device in order to provide a combined configuration of the expansion device and the base device.

2. The expansion device according to claim 1 wherein the plurality of mechanical connectors are configured to ensure alignment of the expansion interface with a corresponding interface on the base device.

3. The expansion device according to claim 1
wherein the expansion interface is configured as a high speed interface and/or high-speed interconnect; and
wherein the base device is configured with the expansion interface configured as a high speed interface and/or high-speed interconnect.

4. The expansion device according to claim 1 wherein the expansion interface is configured to move with respect to the expansion device in at least two directions.

5. The expansion device according to claim 1 wherein the expansion interface is configured to move with respect to the expansion device in three directions.

6. The expansion device according to claim 1 wherein the expansion interface is configured to float with respect to the expansion device in at least two directions.

7. The expansion device according to claim 1 wherein the expansion interface is configured to float with respect to the expansion device in three directions.

8. The expansion device according to claim 1 wherein the expansion interface is configured to rotate with respect to the expansion device in at least one direction.

9. The expansion device according to claim 1 wherein the base device comprises an expansion interface and a plurality of mechanical connectors.

10. (canceled)

11. The expansion device according to claim 1 wherein the expansion device and the base device are configured to have a small form factor and a light weight.

12. The expansion device according to claim 1 wherein the expansion device and the base device are configured to be rugged for implementation in harsh environments.

13. The expansion device according to claim 1 wherein the expansion device is configured with additional computer functionality, computer components, graphics components, processing devices, storage, switch devices, networking devices, and/or routing devices.

14. The expansion device according to claim 1 wherein the expansion interface is configured as a floating connector.

15. The expansion device according to claim 1 wherein the expansion interface avoids a need for a wired connection from a port of the expansion device to a port of the base device.

16. The expansion device according to claim 1 wherein the expansion interface of the expansion device and the expansion interface of the base device are configured as a Peripheral Component Interconnect Express (PCIe) interface.

17. The expansion device according to claim 1 wherein the plurality of mechanical connectors of the expansion device and the plurality of mechanical connectors of the base device are configured as castle connectors.

18. The expansion device according to claim 1 wherein the plurality of mechanical connectors of the expansion device and the plurality of mechanical connectors of the base device comprise configurations where an external expansion interface when connected is sealed to limit damage to the external expansion interface and/or limit interference with the external expansion interface.

19. The expansion device according to claim 1 further comprising a seal configured to seal and/or protect the expansion interface from interference and damage when the expansion device is not connected to the base device.

20. The expansion device according to claim 1 further comprising a lock operation button configured to allow a user to manipulate and configure the plurality of mechanical connectors to be in an unlocked configuration while attaching the base device to the expansion device.

21. The expansion device according to claim 1 wherein aligning the plurality of mechanical connectors of the expansion device with the plurality of mechanical connectors of the base device likewise aligns the expansion interface of the expansion device with the expansion interface of the base device.

22. The expansion device according to claim 1
wherein the plurality of mechanical connectors of the base device have a locked configuration and an unlocked configuration;
wherein the base device comprises a lock operation button; and
wherein operation of the lock operation button by a user places the plurality of mechanical connectors in a locked configuration and/or an unlocked configuration.

23.-25. (canceled)

26. The expansion device according to claim 1 wherein the plurality of mechanical connectors comprise a recess configured to provide a locking functionality with the plurality of mechanical connectors of the base device.

27.-28. (canceled)

29. The expansion device according to claim 1 further comprising an interface printed circuit board configured to support the expansion interface.

30.-33. (canceled)

34. An expansion device comprising:
an expansion interface; and
a plurality of mechanical connectors,
wherein the expansion interface of the expansion device is configured to electrically connect to a base device in order to exchange data and/or signals between the expansion device and the base device;
wherein the plurality of mechanical connectors of the expansion device are configured to mechanically connect the expansion device to the base device in order to provide a combined configuration of the expansion device and the base device; and
wherein the expansion interface is configured to move with respect to the expansion device in at least two directions.

35.-62. (canceled)

63. A system configured for implementation with a base device and an expansion device, the system comprising:
a base device; and
an expansion device comprising an expansion interface and a plurality of mechanical connectors,
wherein the expansion interface of the expansion device is configured to electrically connect to the base device in order to exchange data and/or signals between the expansion device and the base device; and
wherein the plurality of mechanical connectors of the expansion device are configured to mechanically connect the expansion device to the base device in order to provide a combined configuration of the expansion device and the base device.

64.-124. (canceled)
